(19) United States
(12) Patent Application Publication
(10) Pub. No.: US 2015/0306787 A1
(43) Pub. Date: Oct. 29, 2015

(54) Concrete Mixer Drums and Constructions Thereof

(71) Applicant: Walter Wax, Gröbenzell (DE)

(72) Inventor: Walter Wax, Gröbenzell (DE)

(21) Appl. No.: 14/411,782

(22) PCT Filed: Jun. 25, 2012
(86) PCT No.: PCT/IB2012/001256

§ 371 Date: Dec. 29, 2014

(51) Int. Cl. B28C 5/42; B28C 9/04; B01F 13/00; B01F 15/00

(52) U.S. Cl. CPC B28C 5/4268; B01F 15/00831; B28C 9/04; B01F 13/0037; B01F 15/00837; B01F 15/00844; B01F 2215/0047

(57) ABSTRACT

The invention relates to concrete mixer drums and constructions thereof, in particular colored concrete mixers, made of a light metal alloy, in particular made of an aluminum alloy.

### TECHNICAL FIELD

The invention relates to concrete mixer drums and their superstructures, especially truck concrete mixers.

### STATE OF THE ART

In the state of the art truck concrete mixers made of sheet steel are known. Apart from the known effects of the corresponding high weight also the high scrap metal value after wear of the concrete mixer drums made of sheet steel is relatively low.

### DESCRIPTION OF THE INVENTION

Therefore, the invention set itself the object of overcoming the these disadvantages and to obtain an essential reduction of the weight of such concrete mixer drums and at the same time to enable an easier processing of the drums.

This object is reached by replacing the sheet steel by lightweight metal alloys, in particular aluminum alloys, as stated in the main claim.

An essential advantage of the invention also is that by means of the enormous weight savings a corresponding increase of the load capacity, for instance concrete, is allowed and thereby the efficiency of the device usage is increased for the operator.

1. Concrete mixer drums and their superstructures, especially truck concrete mixer, made of a light metal alloy, especially of an aluminum alloy.

2. Concrete mixer drums and their superstructures according to claim 1, characterised in that the common outer dimensions of the drums and superstructures are maintained, whereas the wall thickness increases towards inside in comparison to sheet steel drums, in order to obtain the same stability of sheet steel.

3. Concrete mixer drums and their superstructures according to claim 1, characterised in that they have not to be varnished.

4. Concrete mixer drums and their superstructures according to claim 1, characterised in that they are inside and outside greased and/or lubricated or tarred.

5. Concrete mixer drums and their superstructures according to claim 1, characterised in that they are suited for transporting solid goods, such as coal, gravel, for liquides and pasty substances.

6. Concrete mixer drums and their superstructures according to claim 1, characterised in that the concrete mixer drums are equipped with gas tightness closing charge and feed openings.

7. Concrete mixer drums and their superstructures according to claim 1, characterised in that they are mounted on vehicles or in containers which move or are moved on roads, paths, ferries, railsway carriages, ships, or on the surface of the earth.

8. Concrete mixer drums and their superstructures according to claim 1, characterised in that they have sliprings, brush contacts, electric resistor elements as well as inductivities if required, across which a voltage can be applied, in particular for the transport of tars, fats and other highly viscous substances.

9. Concrete mixer drums and their superstructures according to claim 1, characterised in that they are at least partially made of light metal sponges or foams, preferably beginning as solid material in the inside.

10. Concrete mixer drums and their superstructures according to claim 1, characterised in that the concrete mixer drums have mixing arms and rails, wherein the mixing arms have a T-shaped profile and are inserted in the rails, wherein the mixing arms also can be made of steel.

11. Concrete mixer drums and their superstructures according to claim 10, characterised in that the rails carrying the mixing arms are folded, welded and/or screwed at their ends.

12. Concrete mixer drums and their superstructures according to claim 1, characterised in that the concrete mixer drums are lined at the inside with suitable rubber, such as in the case of Swiss dump trucks, preferably with recycled rubber obtained from truck or aircraft scrap tires by the liquid nitrogen process.

13. Concrete mixer drums and their superstructures according to claim 1, characterised in that concrete mixer drums are lined at the inside with anti-abrasive material, plastic or rubber by liquid or hot coating by spraying.
